(19) United States
(12) Patent Application Publication
(10) Pub. No.: US 2016/0006727 A1
(43) Pub. Date: Jan. 7, 2016

(54) Interconnect Assembly

(71) Applicant: HEWLETT PACKARD DEVELOPMENT COMPANY, L.P., Houston, TX (US)

(72) Inventors: ROBIN T CASTELL, HOUSTON, TX (US); JAMES M MANN, HOUSTON, TX (US)

(73) Assignee: HEWLETT-PACKARD DEVELOPMENT COMPANY, L.P., HOUSTON, TX (US)

(21) Appl. No.: 14/770,809

(22) PCT Filed: Mar. 19, 2013
(86) PCT No.: PCT/US13/32888

§ 371 Date: Aug. 26, 2015

(51) Int. Cl. H04L 29/06; H04W 12/06

(52) U.S. Cl. CPC H04L 63/0853; H04W 12/06

(57) ABSTRACT

An interconnect assembly and authentication method are disclosed herein. An example of the authentication method includes coupling a wireless connector to a wireless communications port and creating a secure pairing between the wireless communications port and the wireless connector. The authentication method additionally includes permitting data to be transceived via the wireless communications port and the wireless connector subsequent to verification of the secure pairing. Other elements and features of the authentication method are disclosed herein as is an example of the interconnect assembly.

### BACKGROUND

Consumers appreciate ease of use and security for their devices. They also appreciate aesthetically pleasing designs. Businesses may, therefore, endeavor to create and provide devices directed toward one or more of these objectives.

### BRIEF DESCRIPTION OF THE DRAWINGS

The following detailed description references the drawings, wherein:

FIG. 1 is an example of an interconnect assembly.

FIG. 2 is an example of an identifier of a security module of the interconnect assembly of FIG. 1.

FIG. 3 is an example of a token of a security module of the interconnect assembly of FIG. 1.

FIG. 4 is an example of the use of near field communications technology bye a security module of the interconnect assembly of FIG. 1.

FIG. 5 is an example of a cable coupled to a wireless connector of the interconnect assembly of FIG. 1.

FIG. 6 is an example of a peripheral coupled to a wireless connector of the interconnect assembly of FIG. 1.

FIG. 7 is an example of an authentication method.

FIG. 8 is an example of an additional element of the authentication method of FIG. 7.

### DETAILED DESCRIPTION

Interconnect assemblies may include various mechanical components or elements, such as prongs, plugs, pins, or clips, which matingly engage a corresponding socket, aperture, opening or receptacle during connection. Examples of such interconnect assemblies include various cable assemblies (e.g., Universal Serial Bus, Video Graphics Array, High Definition Multimedia Interface, IEEE 1394, etc.) for use with devices, such as computers, tablets, mobile phones, televisions, and personal digital assistants.

The mechanical parts of these interconnect assemblies can be subject to damage and/or fatigue which can compromise the integrity of a connection. Additionally, dirt, debris, moisture, and other contaminants may collect on or enter such interconnect assemblies and their corresponding sockets, apertures, openings or receptacles which can render them, and/or any devices to which they are connected, inoperable. Furthermore, such interconnect assemblies and their corresponding sockets, apertures, openings and receptacles may detract from the aesthetics of a device for at least some consumers.

In some instances, it may be desirable to restrict or otherwise limit which interconnect assemblies may attach to and interact with a particular device. This objective may arise, for example, because of a wish to help prevent loss of data or information from a device, a need to help avoid damage to a device as a result of malicious software or malware being introduced via an interconnect assembly, etc.

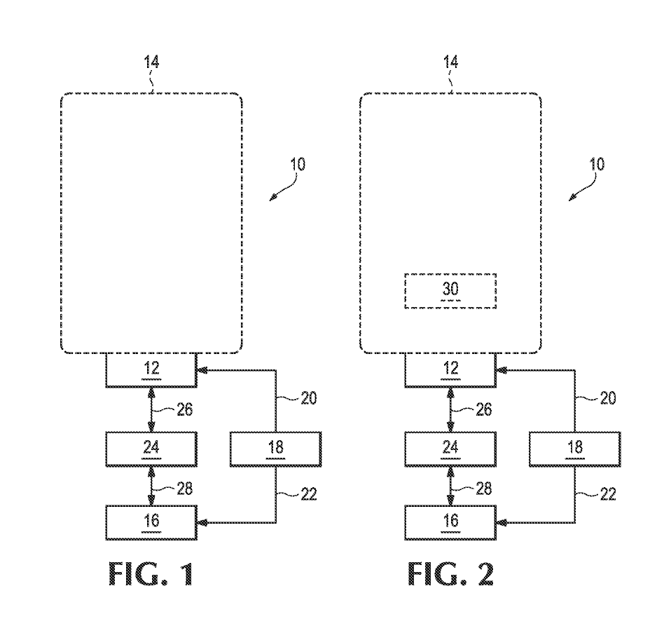

An example of an interconnect assembly 10 that is directed to addressing these objectives is illustrated in FIG. 1. As used herein, the term “cable” is defined as including, but is not necessarily limited to, either (i) one or more wires or cables that transceive data in the form of signals and that may be covered or bound together by a sleeve, insulation, conduit, tape, one or more straps, etc. or (ii) a dongle.

As used herein, the term “dongle” is defined as including, but is not necessarily limited to, an apparatus that provides additional or enhanced functionality (e.g., additional memory, wireless connectivity, etc.) or an apparatus that facilitates the interface or connection between two different types of adapters, protocols, or power sources. Examples of dongles include, but are not limited to, flash memories, secure keys, and connection adapters.

As used herein, the terms “transceive” and “transceived” are defined as including both transmission and reception of data in the form of one or more signals. As used herein, the terms “wireless” and “wirelessly” are defined as including, but are not necessarily limited to, a connection or coupling that does not require mechanical components or elements such as prongs, plugs, pins, or clips that matingly engage a corresponding socket, aperture, opening or receptacle. Wireless connections and couplings may operate in any of a variety of different frequency ranges and wavelengths. They may also be established electrically, magnetically, or optically.

As used herein, the term “device” is defined as including, but is not necessarily limited to, a computer, tablet, mobile phone, television, personal digital assistant, monitor, display, audio component, peripheral, dock, sleeve, docking station, or appliance. As used herein, the term “peripheral” is defined as including, but not necessarily limited to, an apparatus that is connected to a device, but not integrally part of it. Examples of peripherals include, but are not limited to, printers, keyboards, mice, scanners, barcode readers, and external drives.

As used herein, the terms “near field communications” and “NFC” are defined as including, but are not necessarily limited to, a technology for devices to establish communication with each other by touching them together or bringing them into close proximity (e.g., a distance of approximately four (4) centimeters (cm) or less). This communication can be encrypted or unencrypted, This communication may also be established over radio frequencies (e.g., 13.56 megahertz (MHz) on an ISO/IEC 18000-3 air interface) and at varying data rates (e.g., 106 Kbits/sec. to 424 Kbits/sec.). Near field communication devices can engage in two-way communication with one another, as well as one-way communication with near field communication data tags. Portions of near field communication technology have been approved as standards (e.g., ISO/IEC 18092/ECMA-340 and ISO/IEC 21481/ECMA-352).

As used herein, the terms “near field communications data tag” and “NFC data tag” are defined as including, but are not necessarily limited to, a near field communication device gnat contains or stores one or more scripts and/or data. These scripts and/or data may be read-only or rewriteable. As used herein, the terms ‘near field communications reader” and “NFC reader” are defined as including, but are not necessarily limited to, a device that reads or decodes information on an NFC data tag.

Referring again to FIG. 1, interconnect assembly 10 includes a wireless communications port 1 for use with device 14 and a wireless connector 16 to couple with wireless communications port 12. Interconnect assembly 10 also includes a security module 18 to create a secured pairing between wireless communications port 12 and wireless connector 16, as generally indicated by arrows 20 and 22. Interconnect assembly 10 additionally includes an authenticator 24 to verify existence of the secure pairing between wireless communications port 12 and wireless connector 16. Authenticator 24 permits data to be transceived via wireless communications port 12 and wireless connector 16 subsequent to such verification, as generally indicated by double-headed arrows 26 and 28. Additionally, authenticator 24 prohibits data from being transceived via wireless communications port 12 and wireless connector 16 on failure to verify existence of the secure pairing between wireless communications port 12 and wireless connector 16.

Wireless communications port 12 and wireless connector 16 may be implemented in hardware, software, firmware, or a combination of any of these technologies. Similarly, security module 18 and authenticator 24 may also be implemented in hardware, software, firmware, or a combination of any of these technologies.

The use of such wireless technology for connectors 12 and 16 helps to eliminate the issues, described above, associated with interconnect assemblies that utilize mechanical components. Additionally, the use of security module 18 and authenticator 24 provides security by being able to restrict or otherwise limit which interconnect assemblies may attach to and interact with device 14. This provides additional benefits such as helping to prevent loss of data or information from device 14, helping to avoid damage to device 14 as a result of malicious software or malware being introduced via interconnect assembly 10, etc.

An example of an identifier 30 of security module 18 of interconnect assembly 10 is shown in FIG. 2. As can be seen in FIG. 2, in this example, security module 18 includes identifier 30 which is associated with wireless connector 16 that is stored in device 14 to create the secure pairing between wireless communications port 12 and wireless connector 16. In some examples, identifier 30 may include a predetermined number that uniquely identifies wireless connector 16 such as, for example, a serial number, a Globally Unique identifier (GUID), etc. Although not shown in FIG. 2, it is to be understood that in other examples of interconnect assembly 10, identifier 30 of security module 18 may be stored on wireless connector 16 during such initial secure pairing for subsequent use by authenticator 24, rather than in device 14.

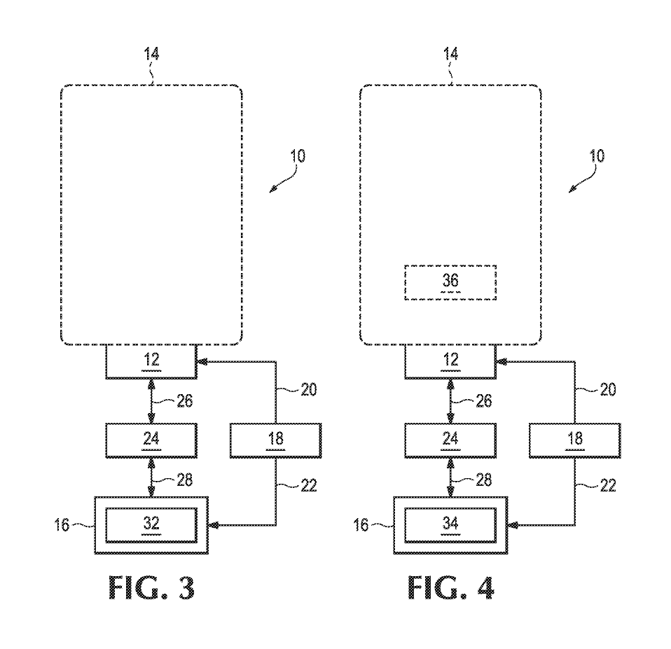

An example of a token 32 of security module 18 of interconnect assembly 10 is shown in FIG. 3. As can be seen in FIG. 3, in this example, security module 18 includes a token 32 transmitted via wireless communications port 12 to wireless connector 16 during an initial secure pairing. As can also be seen in FIG. 3, token 32 is stored on wireless connector 16 for subsequent use by authenticator 24. Although not shown in FIG. 3, it is to be understood that in other examples of interconnect assembly 10, token 32 of security module 18 may be transmitted via wireless connector 16 to wireless communications port 12 during such initial secure pairing. In these other examples, token 32 may then be stored on either wireless communications port 12 or device 14 for subsequent use by authenticator 24.

An example of the use of near field communications technology by security module 18 of interconnect assembly 10 is shown in FIG. 4. As can be seen in FIG. 4, in this example, security module 18 includes a near field communications data tag 34 stored on wireless connector 16 and a near field communications reader 36 in device 14. Security module 18 utilizes NFC reader 36 to obtain information on NFC data tag 34 to create the secure pairing between wireless communications port 12 and wireless connector 16. Although not shown in FIG. 4, it is to be understood that in other examples of interconnect assembly 10, NFC data tag 34 may alternatively be stored on wireless communications port 12 or device 14 and NFC reader 36 may be in wireless connector 16. In such other examples, security module 18 still utilizes NFC reader 36 to obtain information on NFC data tag 34 to create the secure pairing between wireless communications port 12 and wireless connector 16.

In some examples, wireless communications port 12 and wireless connector 16 of interconnect assembly 10 may operate in the extremely high frequency (EHF) range. In other examples, wireless communications port 12 and wireless connector 16 of interconnect assembly 10 may operate substantially at sixty (60) gigahertz (GHz). In still other examples, wireless communications port 12 and wireless connector 16 of interconnect assembly 10 may operate substantially in an infrared frequency range.

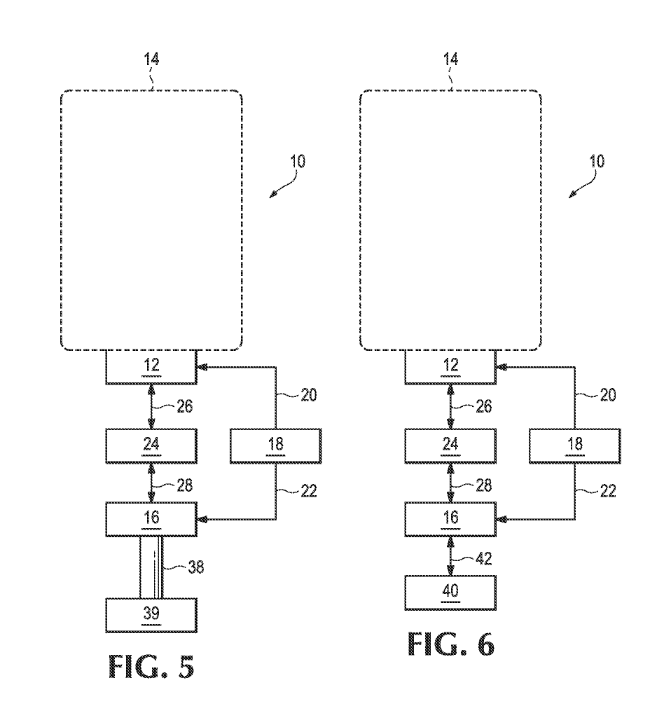

An example of a cable 38 coupled to wireless connector 16 of interconnect assembly 10 is shown in FIG. 5. Cable 38 provides additional flexibility of use of interconnect assembly 10 by allowing other types of devices that do not utilize wireless technology (not shown) to potentially couple to and transceive data with device 14 via connector 39 of cable 38.

An example of a peripheral 40 coupled to wireless connector 16 of interconnect assembly 10 is shown in FIG. 6. As can be seen in FIG. 6, once permitted by security module 18 and authenticator 24, peripheral 40 can wirelessly transceive data to and from device 14, as generally indicated by double-headed arrow 42. This provides additionally flexibility to device 14 such as, for example, the ability to print.

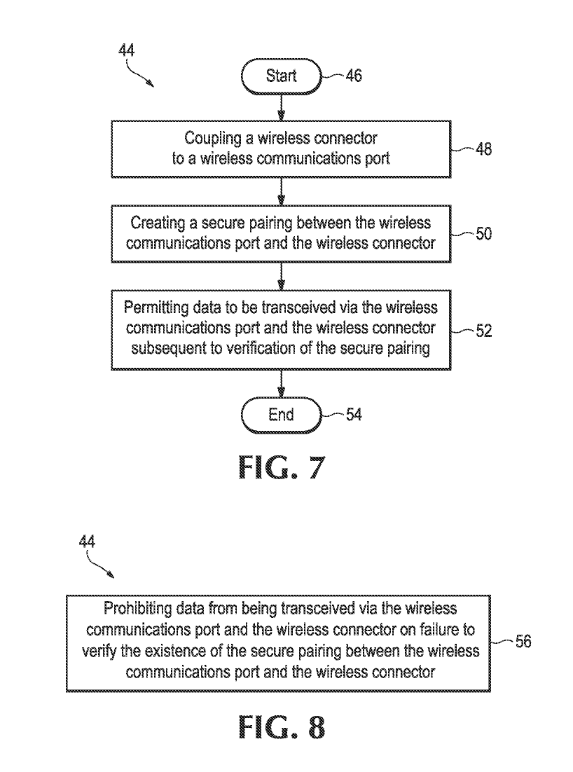

An example of an authentication method 44 is shown in FIG. 7. As can be seen in FIG. 7, method 44 starts or begins 46 by coupling a wireless connector to a wireless communications port, as indicated by block 48. Method 44 continues by creating a secure pairing between the wireless communications port and the wireless connector, as indicated by block 50, and permitting data to be transceived via the wireless communications port and the wireless connector subsequent to verification of the securing pairing, as indicated by block 52. Method 44 may then end 54.

An example of an additional element of authentication method 44 is shown in FIG. 8. As can be seen in FIG. 8, method 44 may additionally include prohibiting data from being transceived via the wireless communications port and the wireless connector on failure to verify the existence of the secure pairing between the wireless communications port and the wireless connector, as indicated by block 56.

Although several examples have been described and illustrated in detail, it is to be clearly understood that the same are intended by way of illustration and example only. These examples are not intended to be exhaustive or to limit the invention to the precise form or to the exemplary embodiments disclosed. Modifications and variations may well be apparent to those of ordinary skill in the art.

Additionally, reference to an element in the singular is not intended to mean one and only one, unless explicitly so stated, but rather means one or more. Moreover, no element or component is intended to be dedicated to the public regardless of whether the element or component is explicitly recited in the following claims.

What is claimed is:

1. An interconnect assembly, comprising:
a wireless communications port for use with a device;
a wireless connector to couple with the wireless communications port;
a security module to create a secured pairing between the wireless communications port and the wireless connector; and
an authenticator to verify existence of the secure pairing between the wireless communications port and the wireless connector, to permit data to be transceived via the wireless communications port and the wireless connector subsequent to such verification, and to prohibit data from being transceived via the wireless communications port and the wireless connector on failure to verify existence of the secure pairing between the wireless communications port and the wireless connector.

2. The interconnect assembly of claim 1, wherein the security module includes an identifier associated with the wireless connector that is stored in the device to create the secure pairing between the wireless communications port and the wireless connector.

3. The interconnect assembly of claim 2, wherein the identifier includes a predetermined number.

4. The interconnect assembly of claim 1, wherein the security module includes a token transmitted via the wireless communications port to the wireless connector during an initial secure pairing, and further wherein the token is stored on the wireless connector for subsequent use by the authenticator.

5. The interconnect assembly of claim 1, wherein the security module includes a near field communications data tag stored on the wireless connector and a near field communications reader in the device to create the secure pairing between the wireless communications port and the wireless connector.

6. The interconnect assembly of claim 1, wherein the wireless connector and the wireless communication port operate in the extremely high frequency (EHF) range.

7. The interconnect assembly of claim 1, wherein the wireless connector and the wireless communications port operate substantially at sixty (60) gigahertz (GHz).

8. The interconnect assembly of claim 1, wherein the wireless connector and wireless communications port operate substantially in an infrared frequency range.

9. The interconnect assembly of claim 1, further comprising a cable connected to the wireless connector.

10. The interconnect assembly of claim 1, further comprising a peripheral coupled to the wireless connector.

11. An authentication method, comprising:
coupling a wireless connector to a wireless communications port;
creating a secure pairing between the wireless communications port and the wireless connector; and
permitting data to be transceived via the wireless communications port and the wireless connector subsequent to verification of the secure pairing.

12. The authentication method of claim 11, further comprising prohibiting data from being transceived via the wireless communications port and the wireless connector on failure to verify the existence of the secure pairing between the wireless communications port and the wireless connector.

13. The authentication method of claim 11, wherein creating a secure pairing between the wireless communications port and the wireless connector includes transmitting a token via the wireless communications port to the wireless connector.

14. The authentication method of claim 13, wherein creating: the secure pairing between the wireless communications port and the wireless connector further includes storing the token on the wireless connector.

15. The authentication method of claim 11, wherein creating a secure pairing between the wireless communications port and the wireless connector includes storing an identifier associated with the wireless connector on a device to which the wireless communications port is connected.
